(19) United States
(12) Patent Application Publication
(10) Pub. No.: US 2023/0079668 A1
(43) Pub. Date: Mar. 16, 2023

(54) REVERSE-FLOW PREVENTION CIRCUIT, POWER SUPPLY CIRCUIT, AND POWER-SUPPLY DEVICE

(71) Applicant: SHARP KABUSHIKI KAISHA, Sakai City (JP)

(72) Inventor: TAKESHI SHIOMI, Sakai City (JP)

(21) Appl. No.: 17/865,982

(22) Filed: Jul. 15, 2022

(30) Foreign Application Priority Data
Sep. 10, 2021 (JP) 2021-148076

(51) Int. Cl. H02H 3/18

(52) U.S. Cl. CPC H02H 3/18

(57) ABSTRACT

A reverse-flow prevention circuit includes: an n-channel metal-oxide semiconductor having an anode terminal, a cathode terminal, and a control terminal; a reference voltage node; an output voltage node; a first rectifier element, a second rectifier element, and a third rectifier element; a secondary-side winding of a transformer having a center tap terminal; a voltage regulator having an input terminal, an output terminal, and a reference voltage terminal; and a transistor having a high-voltage terminal, a low-voltage terminal, and a control terminal.

### CROSS-REFERENCE TO RELATED APPLICATION

The present application claims priority from Japanese Patent Application Number 2021-148076, the content to which is hereby incorporated by reference into this application.

### BACKGROUND OF THE INVENTION

### 1. Field of the Invention

The present disclosure relates a reverse-flow prevention circuit.

### 2. Description of the Related Art

Heretofore, a reverse-flow prevention circuit constituted by a metal-oxide semiconductor (MOS) in order to prevent reverse flow of output current has been used at an output portion in a power supply circuit parallelized with another power supply circuit. One example of the reverse-flow prevention circuit is disclosed in Japanese Unexamined Patent Application Publication No. 2006-311740.

However, such a reverse-flow prevention circuit still has room for improvement.

It is desirable to provide a reverse-flow prevention circuit that can be easily controlled than in the related art.

### SUMMARY OF THE INVENTION

According to an aspect of the disclosure, there is provided a reverse-flow prevention circuit including: an n-channel metal-oxide semiconductor (NMOS) having an anode terminal, a cathode terminal, and a control terminal; a reference voltage node; an output voltage node; a first rectifier element, a second rectifier element, and a third rectifier element; a secondary-side winding of a transformer having a center tap terminal; a voltage regulator having an input terminal, an output terminal, and a reference voltage terminal; and a transistor having a high-voltage terminal, a low-voltage terminal, and a control terminal. A cathode terminal of the first rectifier element and an anode terminal of the third rectifier element are connected to one end of the secondary-side winding; a cathode terminal of the second rectifier element is connected to another end of the secondary-side winding; an anode terminal of the first rectifier element, an anode terminal of the second rectifier element, and the low-voltage terminal of the transistor are connected to the reference voltage node; the input terminal of the voltage regulator is connected to a cathode terminal of the third rectifier element; the reference voltage terminal of the voltage regulator is connected to the output voltage node; the center tap terminal of the secondary-side winding is connected to the output voltage node directly or via a coil; the anode terminal of the NMOS is connected to the output voltage node; and the control terminal of the NMOS has a path connected to the output terminal of the voltage regulator and a path connected to the high-voltage terminal of the transistor.

### BRIEF DESCRIPTION OF THE DRAWINGS

FIG. 1 is a diagram illustrating a circuit configuration of a reverse-flow prevention circuit according to one embodiment of the present disclosure, the reverse-flow prevention circuit including a gate drive circuit;

FIG. 2 is a graph illustrating voltage waveforms of individual portions in the reverse-flow prevention circuit according to one embodiment of the present disclosure; and

FIG. 3 is a power-supply device including power supply circuits, each including the reverse-flow prevention circuit according to one embodiment of the present disclosure.

### DETAILED DESCRIPTION OF THE INVENTION

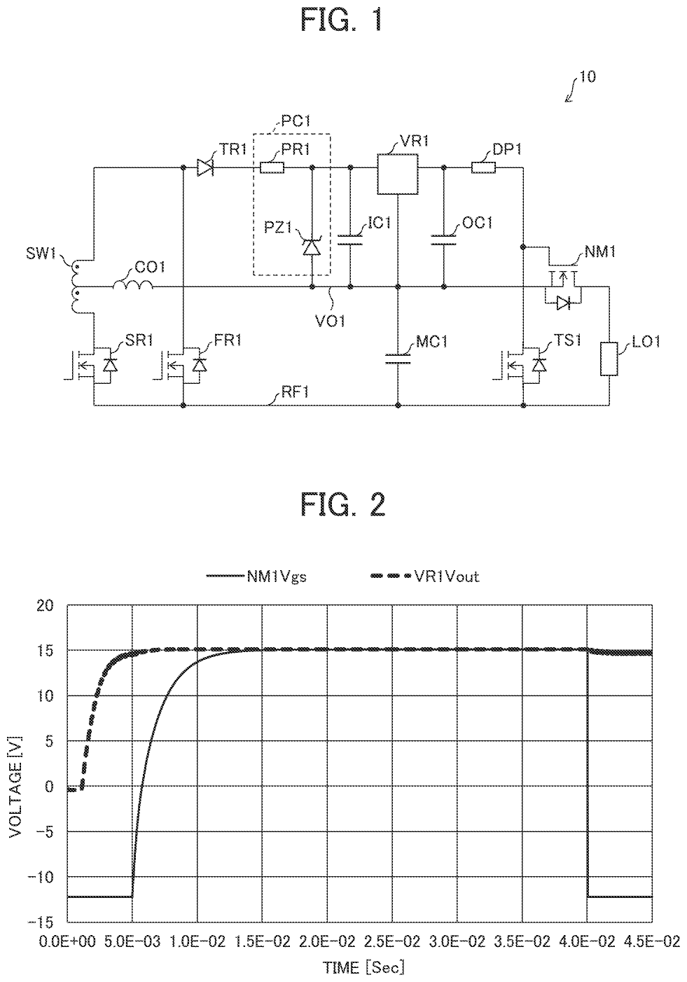

FIG. 1 is a diagram illustrating a circuit configuration of a reverse-flow prevention circuit 10 according to one embodiment of the present disclosure. The reverse-flow prevention circuit 10 includes a gate drive circuit. In the reverse-flow prevention circuit 10 disclosed in the present embodiment, in order to cause a metal-oxide semiconductor (MOS) to function as a diode in which a forward voltage drop is small, a gate of the MOS is turned on during passing of forward current.

Herein, for simplicity of description, for example, a “first rectifier element FR1” may also be referred to simply as “FR1”.

### Definitions of Terms

Before the reverse-flow prevention circuit 10 is described, terms are defined herein as described below.
Transistor: an element having three terminals, namely, a high-voltage terminal, a low-voltage terminal, and a control terminal, which are described below. In the transistor, passing and not passing current from the high-voltage terminal to the low-voltage terminal can be controlled by voltage or current control of the control terminal. A metal-oxide semiconductor (MOS) transistor and a bipolar transistor also correspond to the transistor.

When a transistor is an n-channel metal oxide semiconductor (NMOS) transistor, a drain thereof is a high-voltage terminal, a source is a low-voltage terminal, and a gate is a control terminal. When a voltage between the gate and the source of the transistor becomes higher than or equal to a threshold voltage, current flows from the high-voltage terminal to the low-voltage terminal. When a transistor is a negative-positive-negative (NPN) bipolar transistor, a collector thereof is a high-voltage terminal, an emitter is a low-voltage terminal, and a base is a control terminal. When current is passed to the control terminal, current flows from the high-voltage terminal to the low-voltage terminal.
High-voltage terminal: a terminal that is used through application of a higher voltage than a voltage applied to a low-voltage terminal
Low-voltage terminal: a terminal that is used through application of a lower voltage than a voltage applied to a high-voltage terminal
Rectifier element: an element typified by a diode and passes current from an anode terminal to a cathode terminal. The rectifier element includes an element typified by an NMOS. When the rectifier element is an NMOS, the source and the drain can be defined as an anode terminal and a cathode terminal, respectively.
Voltage regulator: a circuit that outputs a predetermined voltage independently of variations in an input voltage or a load, or an electronic component into which the circuit is incorporated. A linear regulator and a switching regulator correspond to the voltage regulator. Each of these regulators has an input terminal that receives power, an output terminal that outputs power, and a reference voltage terminal connected to a node that serves as a reference for an input/output voltage.
Series regulator: included in a linear regulator, and low drop-out regulator (LDO) or the like corresponds thereto. The series regulator has an advantage in that power consumption in output specifications is low.

A series regulator is the most appropriate as a power supply used for the reverse-flow prevention circuit 10, since power consumed is due only to leakage current (i.e., is substantially zero) when the gate of the NMOS is in an on state. Since a voltage higher than or equal to about 10 V, which is relatively high, is used in order to reduce the on-resistance of an NMOS (which is NM1 described below) included in the reverse-flow prevention circuit 10, selecting a series regulator having an output specification of about 1 A or less makes it possible to miniaturize the series regulator. The upper limit of the voltage is about 20 V, and when the voltage exceeds it, the reliability of the control terminal (gate) of NM1 deteriorates.

### (Elements That Constitute Reverse-Flow Prevention Circuit 10)

As illustrated in FIG. 1, the reverse-flow prevention circuit 10 using NM1 includes NM1, RF1, VO1, FR1, SR1, CO1, TR1, PC1 (PR1 and PZ1), SW1, VR1, TS1, DP1, IC1, OC1, and MC1. Also, LO1 is connected to the reverse-flow prevention circuit 10, as illustrated in FIG. 1. These elements will be described below.

### (Major Circuit Configuration of Reverse-Flow Prevention Circuit 10)

Major elements of the reverse-flow prevention circuit 10 using NM1 are NM1, RF1, VO1, FR1, SR1, TR1, SW1, VR1, and TS1.

SW1 is a secondary-side winding of a transformer having a center tap terminal. CO1 is a coil having an inductance of about 2.5 H and a resistance of about 300 μΩ. FR1 is a first rectifier element including an NMOS parallelized so that a threshold voltage becomes about 3.3 V, and an on-resistance becomes about 300 μΩ. SR1 is a second rectifier element using an NMOS having the same configuration as FR1. TR1 is a third rectifier element using a fast recovery diode (FRD) having a withstand voltage of about 90 V and a forward voltage of about 0.6 V.

PC1 is a circuit that is constituted by PR1 and PZ1 and that protects elements at a subsequent stage from noise. PR1 is a resistor for protection and has a resistance of about 1 kΩ. PZ1 is a Zener diode having a breakdown voltage of about 56 V. VR1 is constituted by an LDO and is a voltage regulator having an output voltage of about 15 V and an output current of about 0.2 A. VR1 is desirably a series regulator having output specifications of about 10 V or higher and about 1 A or less. VR1 is a power supply for driving the gate of NM1. IC1 is a voltage stabilizing capacitor having an electrostatic capacitance of about 0.1 μF. OC1 is an output-voltage stabilizing capacitor having an electrostatic capacitance of about 0.1 μF. DP1 is a resistor having a resistance of about 30 kΩ. NM1 is an element for reverse-flow prevention and is constituted by an NMOS parallelized so that a threshold voltage becomes about 1.6 V, and an on-resistance becomes about 70 μΩ. NM1 has an anode terminal, a cathode terminal, and a control terminal. TS1 is a transistor constituted by an NMOS having a threshold voltage of about 1.6 V and an on-resistance of about 2Ω. TS1 is a gate drive circuit for NM1.

MC1 is a capacitor constituted by a capacitor parallelized so that the electrostatic capacitance becomes about 10 mF. LO1 is a resistor configured so that a load becomes about 2 kW. RF1 is a reference voltage node (about 0 V). VO1 is an output voltage node (about 12.2 V).

Since PC1 is a noise removing circuit, PC1 may be omitted from the reverse-flow prevention circuit 10 under a situation in which noise does not cause a problem in the reverse-flow prevention circuit 10. An output terminal of PC1 corresponds to a cathode terminal of PZ1. Even when noise that exceeds about 56 V is mixed in the voltage, the voltage is limited to about 56 V. This is also because the voltage of PC1 is regulated. Such a noise removing circuit is also defined as a shunt regulator. An input terminal of PC1 is connected to a cathode terminal of TR1. The output terminal of PC1 corresponds to the cathode terminal of PZ1, and a reference voltage terminal of PC1 corresponds to an anode terminal of PZ1. Since the voltage of PC1 can be regulated by adjusting a Zener breakdown voltage of PZ1, PC1 can also be used instead of VR1.

### (Connection Relationships of Elements That Constitute Reverse-Flow Prevention Circuit 10)

A cathode terminal of FR1 and an anode terminal of TR1 are connected to one end of SW1. A cathode terminal of SR1 is connected to another end of SW1. An anode terminal of FR1, an anode terminal of SR1, and a low-voltage terminal of TS1 are connected to RF1. An input terminal of VR1 is connected to the cathode terminal of TR1, and a reference voltage terminal of VR1 is connected to VO1. The center tap terminal of SW1 is connected to VO1 via CO1. The center tap terminal of SW1 may also be directly connected to VO1 without CO1 being interposed therebetween. The anode terminal of NM1 is connected to VO1. The control terminal (gate) of NM1 has a path connected to an output terminal of VR1 and a path connected to a high-voltage terminal of TS1.

DP1 is connected to a path that is connected from the control terminal (gate) of NM1 to the output terminal of VR1.

LO1 is a load connected for testing the reverse-flow prevention circuit 10. One end of LO1 is connected to a cathode terminal of NM1, and another end of LO1 is connected to RF1. The cathode terminal of NM1 corresponds to an output terminal of the reverse-flow prevention circuit 10. The control terminals of FR1, SR1, and TS1 are connected to a control circuit 20 described below. The control circuit 20 controls the control terminals of FR1, SR1, and TS1.

IC1 and OC1 are capacitors incorporated into the reverse-flow prevention circuit 10 for stable operation of VR1. The capacitors may or may not be incorporated depending on detailed specifications of the reverse-flow prevention circuit 10 and VR1. Thus, IC1 and OC1 may be omitted from the reverse-flow prevention circuit 10.

DP1 is incorporated into the reverse-flow prevention circuit 10 in order to adjust the turn-on speed of NM1 or in order to suppress discharging of OC1 caused by turning-on of TS1. When the adjustment or the discharging suppression is not to be performed by DP1, DP1 may be omitted from the reverse-flow prevention circuit 10.

MC1 is a capacitor for stabilizing a voltage of VO1. The size of the electrostatic capacitance of MC1, whether or not MC1 is to be incorporated, the position into which MC1 is incorporated, and so on vary depending on detailed specifications of the reverse-flow prevention circuit 10. Also, MC1 may be used in the reverse-flow prevention circuit 10, as appropriate.

### (Circuit Operation of Reverse-Flow Prevention Circuit 10)

FIG. 2 is a graph illustrating voltage waveforms of individual portions in the reverse-flow prevention circuit 10 according to one embodiment of the present disclosure. The circuit operation of the reverse-flow prevention circuit 10 can be discussed in two separate processes below:

First process: Starting raising an output voltage of VR1, and

Second process: Control on NM1.

NM1Vgs in FIG. 2 represents a voltage between the gate and the source of NM1 in the present embodiment. VR1Vout in FIG. 2 represents the output voltage of VR1 in the present embodiment.

The start of raising the output voltage of VR1 is performed in the following manner. First, TS1 is turned on to thereby turn off NM1. This is to prevent reverse current flow due to unintended turning-on of NM1. A primary-side winding (not illustrated) of the transformer is excited by rectangular waves, so that an electromotive voltage of about 66 kHz occurs at SW1 at about 35 V. This voltage is rectified by FR1 and SR1 and is further smoothed by CO1 and MC1, so that an output voltage of about 12.2 V is generated in VO1. Meanwhile, about 22.8 V (35 V-12.2 V) that is a voltage rectified by TR1 and based on VO1 is smoothed by IC1. VR1 to which about 22.8 V is input outputs about 15 V, and this voltage is stabilized by OC1. It can be understood from FIG. 2 that VR1Vout rises to about 15 V, which is a predetermined voltage, at about 5 milliseconds (ms) from when the excitation of the transformer is started.

The reverse-flow prevention circuit 10 employs CO1 in order to excite the transformer with rectangular waves. In the case of sine wave excitation in an inductor-inductor-capacitor (LLC) converter or the like, CO1 may be omitted from the reverse-flow prevention circuit 10. Thus, CO1 is not essential in the reverse-flow prevention circuit 10.

The control on NM1 is performed by the control circuit 20 determining (also including estimating) that

the output voltage of VR1 is higher than or equal to a threshold voltage of NM1 (the output voltage does not necessarily have to be about 15 V) and

forward current flows to NM1 via a parasitic diode and turning off TS1.

NM1 is turned on with a time constant of an input electrostatic capacitance (Ciss) and a resistance value of DP1. When NM1 is turned on, a forward voltage drop is reduced.

When reverse current flows in NM1 or the control circuit 20 predicts or detects the flow of reverse current, the control circuit 20 turns on TS1. As a result, NM1 is turned off, which can stop the reverse current. TS1 is turned off at time 5 ms illustrated in FIG. 2, so that NM1Vgs reaches about 15 V slowly, taking about 10 ms. Since DP1 slowly turns on NM1, transient current is suppressed, thus making it possible to suppress malfunction of the entire reverse-flow prevention circuit 10. Turning off NM1 at high speed, as illustrated at time 40 ms, makes it possible to block the reverse current at high speed.

### (Optimum Range of Output Voltage Node VO1)

It is desirable that the reverse-flow prevention circuit 10 be turned off at high speed when reverse current flows. Thus, when NM1 is turned off at high speed, it is desirable that a large negative voltage be applied as a gate voltage. In the present embodiment, a gate voltage of about −12.2 V is applied based on the anode terminal (source) of NM1 to thereby perform high-speed operation. The optimum range of the gate voltage is the range of about −3 V to −20 V. When the gate voltage is about −3 V or more, the effect of the high-speed operation decreases. When the gate voltage is about −20 V or less, a possibility that the control terminal (gate) of NM1 is damaged arises.

In order for the gate voltage relative to the source to be in the range of about −3 V to −20 V, VO1 relative to RF1 is in the range of about 3 V to 20 V.

### (Power Supply Circuits 100 and 101 Including Reverse-Flow Prevention Circuit 10)

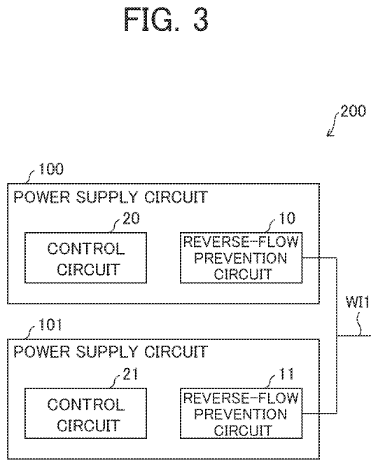

FIG. 3 is a diagram illustrating a power-supply device including power supply circuits, each including the reverse-flow prevention circuit according to one embodiment of the present disclosure. As illustrated in FIG. 3, a power-supply device 200 includes the power supply circuit 100 and a power supply circuit 101. The power supply circuit 100 includes the reverse-flow prevention circuit 10 and the control circuit 20. Thus, the power supply circuit 100 can realize a reverse-flow prevention function by simple control.

As illustrated in FIG. 3, the power supply circuit 101 includes a reverse-flow prevention circuit 11 and a control circuit 21. The power supply circuit 101 has a configuration that is the same as that of the power supply circuit 100. That is, the reverse-flow prevention circuit 11 has a configuration that is the same as that of the reverse-flow prevention circuit 10, and the control circuit 21 has a configuration that is the same as that of the control circuit 20. That is, as in the power supply circuit 100, the power supply circuit 101 can realize a reverse-flow prevention function by simple control.

### (Parallel Connection of Power Supply Circuits 100 and 101)

As illustrated in FIG. 3, in the power-supply device 200, an output terminal (the cathode terminal of NM1) of the power supply circuit 100 and an output terminal (the cathode terminal of NM1) of the power supply circuit 101 are connected to each other through a wire WI1. That is, the power-supply device 200 includes a configuration in which the power supply circuits 100 and 101 are connected in parallel. Since the power supply circuits 100 and 101 have the same configuration, the reverse-flow prevention circuit 10 or 11 can prevent flow of current from one power supply circuit to the other power supply circuit, even when the output terminals of the power supply circuits 100 and 101 are connected to each other through the WI1. Thus, the power-supply device 200 having the configuration in which the power supply circuits 100 and 101 are connected in parallel can perform power-supply parallel operation while preventing reverse flow as described above.

It is to be noted that the numerical values mentioned above are merely examples. In order to adjust the circuit operation of the reverse-flow prevention circuit 10, for example, a resistor can be additionally provided on a wire in the reverse-flow prevention circuit 10, or a capacitor can also be additionally provided between wires, as appropriate.

While there have been described what are at present considered to be certain embodiments of the invention, it will be understood that various modifications may be made thereto, and it is intended that the appended claims cover all such modifications as fall within the true spirit and scope of the invention.

The present disclosure contains subject matter related to that disclosed in Japanese Priority Patent Application JP 2021-148076 filed in the Japan Patent Office on Sep. 10, 2021, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A reverse-flow prevention circuit comprising:
an n-channel metal-oxide semiconductor having an anode terminal, a cathode terminal, and a control terminal;
a reference voltage node;
an output voltage node;
a first rectifier element, a second rectifier element, and a third rectifier element;
a secondary-side winding of a transformer having a center tap terminal;
a voltage regulator having an input terminal, an output terminal, and a reference voltage terminal; and
a transistor having a high-voltage terminal, a low-voltage terminal, and a control terminal,
wherein a cathode terminal of the first rectifier element and an anode terminal of the third rectifier element are connected to one end of the secondary-side winding;
a cathode terminal of the second rectifier element is connected to another end of the secondary-side winding;
an anode terminal of the first rectifier element, an anode terminal of the second rectifier element, and the low-voltage terminal of the transistor are connected to the reference voltage node;
the input terminal of the voltage regulator is connected to a cathode terminal of the third rectifier element;
the reference voltage terminal of the voltage regulator is connected to the output voltage node;
the center tap terminal of the secondary-side winding is connected to the output voltage node directly or via a coil;
the anode terminal of the n-channel metal-oxide semiconductor is connected to the output voltage node; and
the control terminal of the n-channel metal-oxide semiconductor has a path connected to the output terminal of the voltage regulator and a path connected to the high-voltage terminal of the transistor.

2. The reverse-flow prevention circuit according to claim 1,
wherein the voltage regulator is a series regulator having output specifications of substantially 10 V or higher and substantially 1 A or less.

3. The reverse-flow prevention circuit according to claim 1,
wherein the output voltage node has a voltage of substantially 3 V to 20 V.

4. The reverse-flow prevention circuit according to claim 1,
wherein a resistor is connected to the path connected from the control terminal of the n-channel metal-oxide semiconductor to the output terminal of the voltage regulator.

5. A power supply circuit comprising:
the reverse-flow prevention circuit according to claim 1.

6. A power-supply device comprising:
the power supply circuit according to claim 5, the power supply circuit being connected in parallel.
